(19) United States
(12) Patent Application Publication
(10) Pub. No.: US 2012/0140463 A1
(43) Pub. Date: Jun. 7, 2012

(54) LED PROFILE LUMINAIRE

(76) Inventors: David J. Kinzer, Baraboo, WI (US); Frank Tornyai, Madison, WI (US)

(21) Appl. No.: 13/229,379

(22) Filed: Sep. 9, 2011

Related U.S. Application Data
(60) Provisional application No. 61/420,647, filed on Dec. 7, 2010.
(60) Provisional application No. 61/450,679, filed on Mar. 9, 2011.
(60) Provisional application No. 61/495,561, filed on Jun. 10, 2011.

(51) Int. Cl. F21V 7/04; F21V 7/06

(52) U.S. Cl. 362/231; 362/235

(57) ABSTRACT

A lighting fixture comprising a light source including an array of LEDs, a plurality of collimating optics, and a light-mixing assembly comprising a reflective tube having a converging section and a diverging section. The array comprises LEDs have a plurality of colors, such as at least one white LED and at least one amber LED positioned on a perimeter of the array. The reflective tube preferably includes a necked portion between the converging section and the diverging section. For example, a sidewall of the reflective tube can be longitudinally curved (e.g., in the shape of an asphere or a parabola). In one embodiment, a shape of the sidewall of the reflective tube can be adjustable to modify the light wash exiting the light-mixing assembly.

### FIELD OF THE INVENTION

The present invention relates to profile luminaires, and more particularly to LED profile luminaires.

### BACKGROUND OF THE INVENTION

Profile luminaires are often used for stage lighting where a light output is shaped to the profile of an object. Such luminaires typically include a lamp with a filament, an ellipsoidal reflector, a gate, and an adjustable tube containing a lens. The lamp includes a filament that is mounted at a focal point of the ellipsoidal reflector. The ellipsoidal reflector is used to collect and direct a light wash from the lamp and through the gate. The gate passes the light into the lens tube, which can be adjusted to change the focus of the light wash by changing the distance between the gate and the lens.

### SUMMARY OF THE INVENTION

The present invention provides a lighting fixture comprising a light source including an array of LEDs, a plurality of collimating optics, each positioned to collimate light from at least one of the LEDs, and a light-mixing assembly positioned to receive light from the collimating optics. The light-mixing assembly comprises a reflective tube having a converging section and a diverging section.

In one embodiment, the array comprises LEDs have a plurality of colors. Preferably, at least one of the LEDs comprises an amber LED and at least one of the LEDs comprises a white LED, and the amber LED and the white LED are positioned on a perimeter of the array. The collimating optics can be molded plastic optics that work via total internal reflection, a photonic lattice structure applied to the LEDs, or any other suitable structure.

In a preferred embodiment, the reflective tube has a polygonal cross section (e.g., a hexagon). The tube can has a reflective surface including specular aluminum (e.g., Alanod MIRO), a prismatic V-groove structure (e.g., 3M® Optical Lighting Film), or any other suitable structure.

The reflective tube preferably includes a necked portion between the converging section and the diverging section. For example, a sidewall of the reflective tube can be longitudinally curved (e.g., in the shape of an asphere or a parabola). In one embodiment, a shape of the sidewall of the reflective tube can be adjustable to modify the light wash exiting the light-mixing assembly.

Other features and aspects of the invention will become apparent by consideration of the following detailed description and accompanying drawings.

### BRIEF DESCRIPTION OF THE DRAWINGS

FIG. 1 is a perspective view of a lighting fixture embodying features of the present invention and including a light source, a mixing assembly, a gate assembly, and a lens assembly.

FIG. 2 is an exploded perspective view of the lighting fixture in FIG. 1.

FIG. 3 is a section view taking along line 3-3 in FIG. 1.

FIG. 4 is an exploded perspective view of the light source in FIG. 2 having a hexagonal array of LEDs.

FIG. 5 is a plan view of hexagonal array of LEDs.

FIG. 6 is an enlarged section view of the light source taken along line 6-6 in FIG. 2.

FIG. 7 is an exploded perspective view of the mixing assembly in FIG. 2.

FIG. 8 is an exploded perspective view of the gate assembly in FIG. 2.

FIG. 9 is an exploded perspective view of the lens assembly in FIG. 2.

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting.

### DETAILED DESCRIPTION

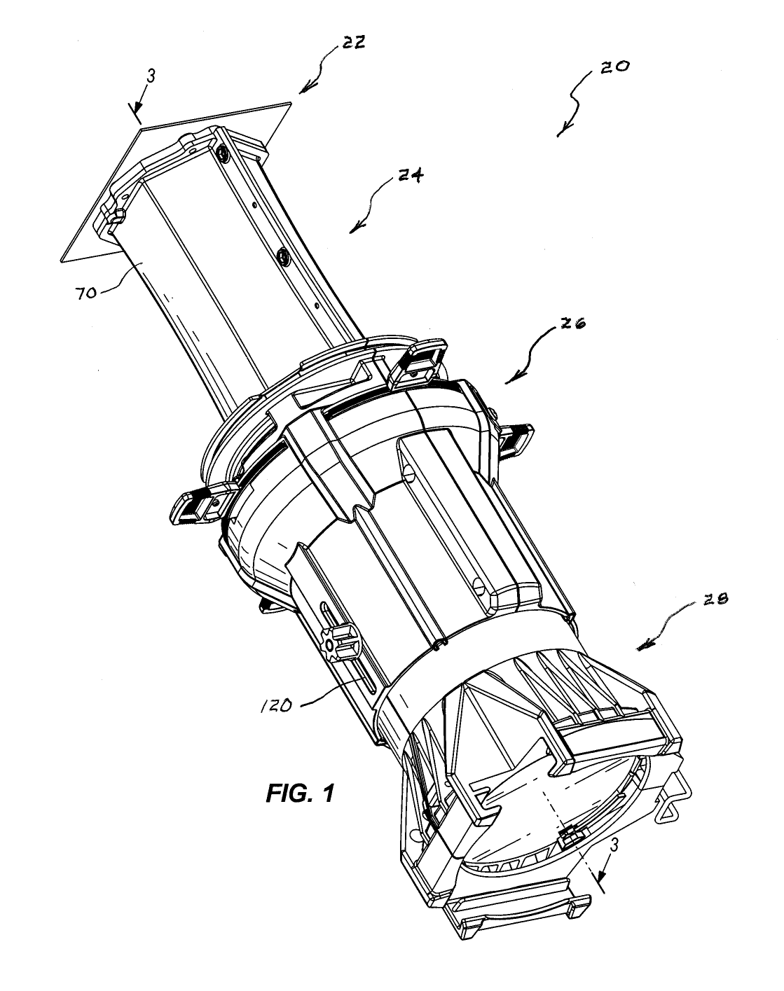

The lighting fixture 20 illustrated FIGS. 1-3 is a luminaire that can be used for entertainment lighting, such as in a theatre or studio. The lighting fixture 20 includes a light source 22 that produces light, a mixing assembly 24 that mixes the light, a gate assembly 26 through which the light passes after exiting the mixing assembly 24, and a lens assembly 28 that receives the light from the gate assembly 26 and projects it toward the desired location.

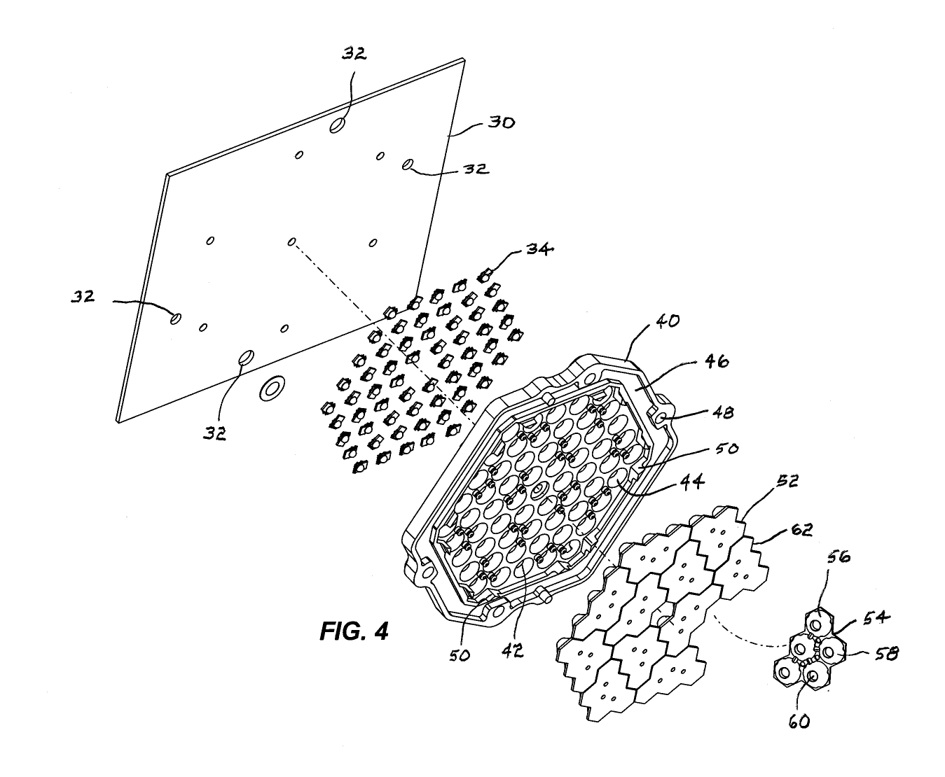

Referring to FIG. 4, the illustrated light source 22 is an LED assembly that produces light in multiple wave lengths. The LED assembly includes a printed circuit board 30 including four mounting holes 32 supporting a plurality of the LEDs 34 arranged in a hexagonal array. In the illustrated embodiment, the hexagonal array includes sixty LEDs 34, with five LEDs 34 arranged along each side of the six-sided array. The array is sixty-nine millimeters side-to-side and eighty millimeters corner-to-corner. Each LED 34 is spaced from the adjacent LEDs 34 by a distance of about ten millimeters, and there is no LED at the center of the array.

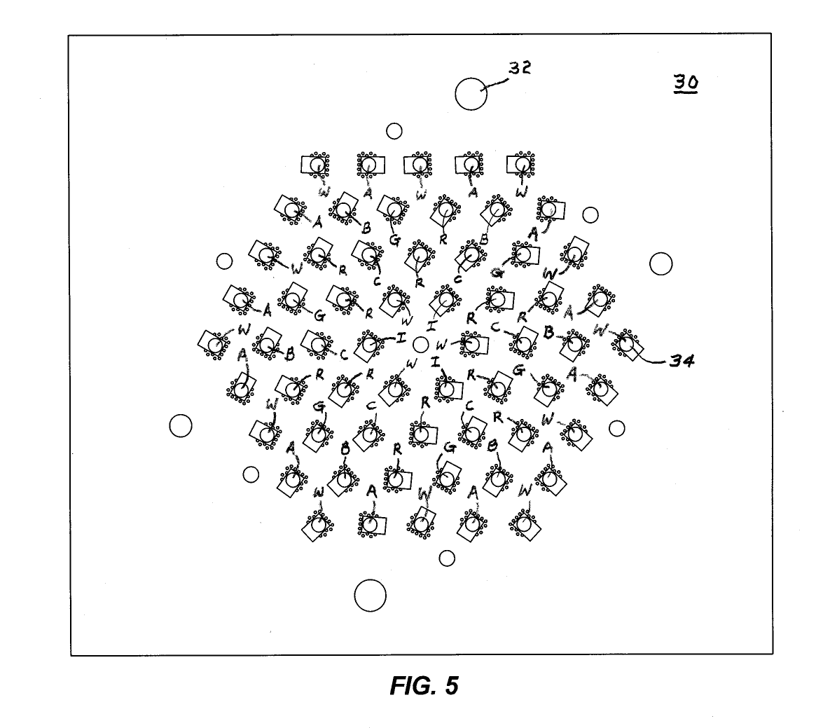

The illustrated array includes LEDs 34 of the following colors and quantities: red-12, amber-12, blue-6, green-6, cyan-6, indigo-3, and white-15 (labeled R, A, B, G, C, I and W, respectively). As can be seen in FIG. 5, the LEDs 34 of a common color are symmetrically arranged around the center of the array in symmetrical groups of three.

Mixing of white light emitted from the perimeter of the array tends to be less efficient, and thus it is desirable to position in this region LEDs 34 that have wider beams, such as white LEDs and amber LEDs. In this regard, in the illustrated embodiment, the outer perimeter of the array is populated with alternating white LEDs and amber LEDs. The wider beams of these LEDs tend to produce inherently better mixing.

A primary optic holder 40 is mounted on the printed circuit board 30 and includes a series of through holes 42 that are each adapted to receive the corresponding LED 34. Each through hole 42 includes a tapered surface 44 that surrounds the corresponding LED 34. The primary optic holder 40 further includes a perimeter recess 46 around its perimeter and adapted to receive a gasket (not shown) to inhibit contamination of the mixing assembly 24. The primary Optic holder 40 further include a series of four mounting holes 48 aligned with the four mounting holes 32 on the printed circuit board 30. A series of twelve mirror tabs 50 are positioned adjacent the perimeter recess 46.

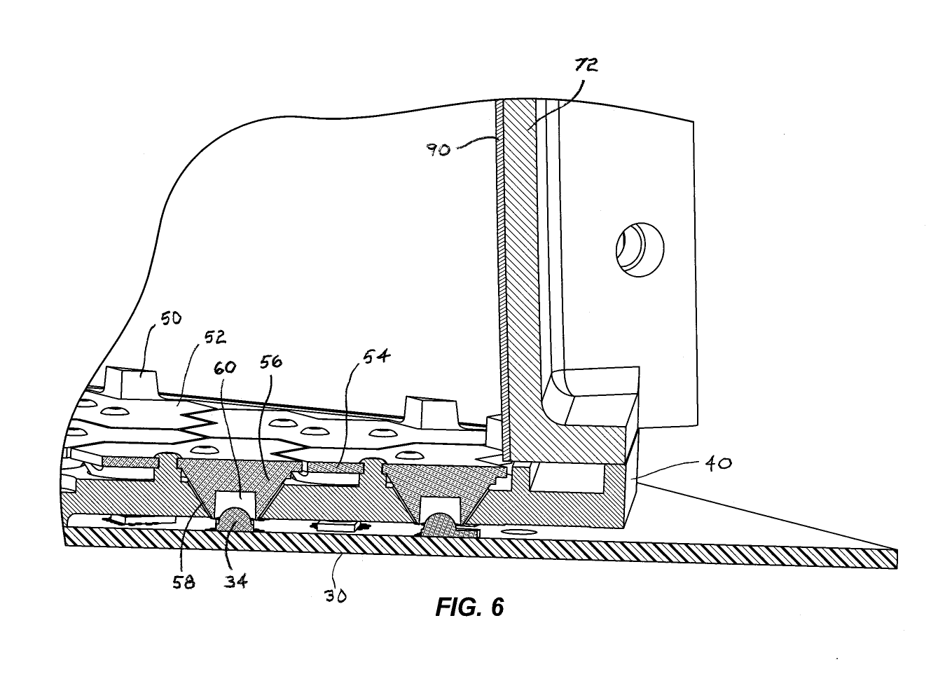

Referring to FIGS. 4 and 6, the light source 22 further includes collimating optics in the form of twelve collimator packs 52 ultrasonically welded to the primary optic holder 40. Each collimator pack 52 includes a back plate 54 and five collimator lenses 56 protruding from the back plate 54 toward the primary optic holder 40. Each collimator lens 56 is positioned in a corresponding through hole 42 of the primary optic holder 40 and includes a parabolic surface 58 that functions to reflect light from the corresponding LED 34 into the mixing assembly 24 by total internal reflection. The surface of the collimator lens 56 is slightly spaced from the tapered surface 44 of the primary optic holder 40. Each collimator lens 56 includes a cylindrical recess 60 that receives the corresponding LED 34. The back plate 54 of each collimator pack 52 includes a contoured edge 62 that is adapted to mate with the corresponding contoured edge 62 of the adjacent back plate 54. In the illustrated embodiment, the contoured edge 62 has a partial hexagonal shape.

The illustrated collimator packs are molded plastic optics that work via total internal reflection. Alternatively, the collimating optics could be a photonic lattice structure applied to the LEDs.

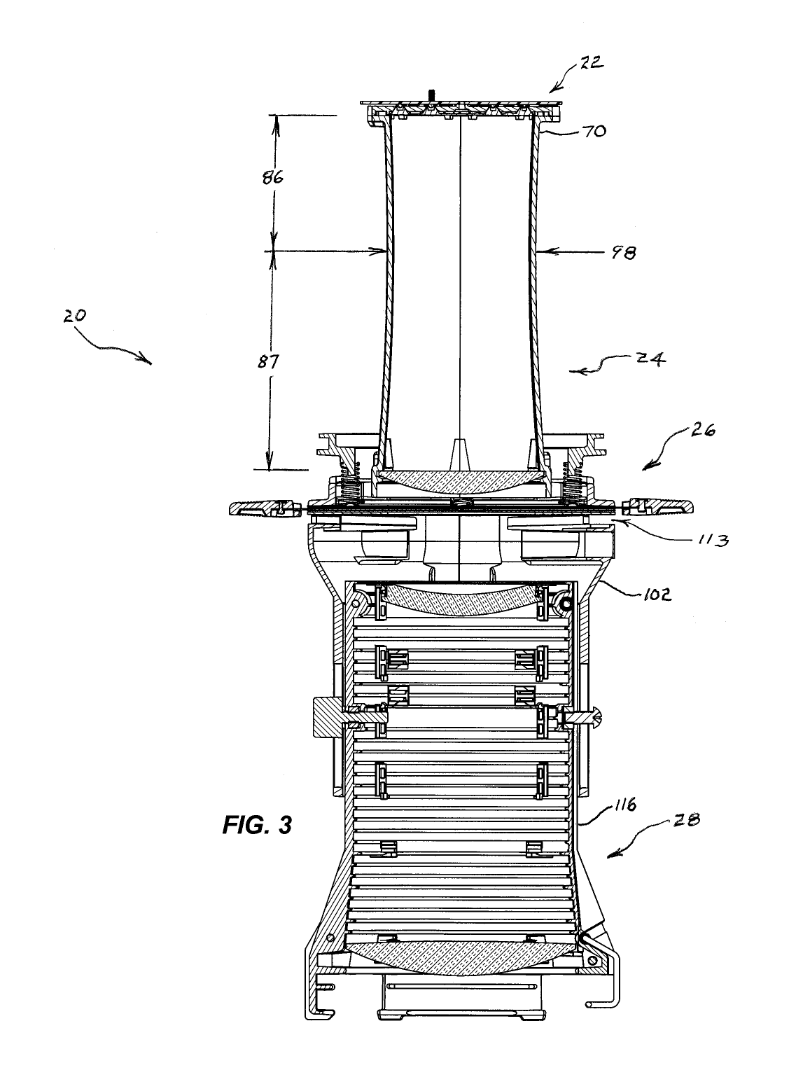

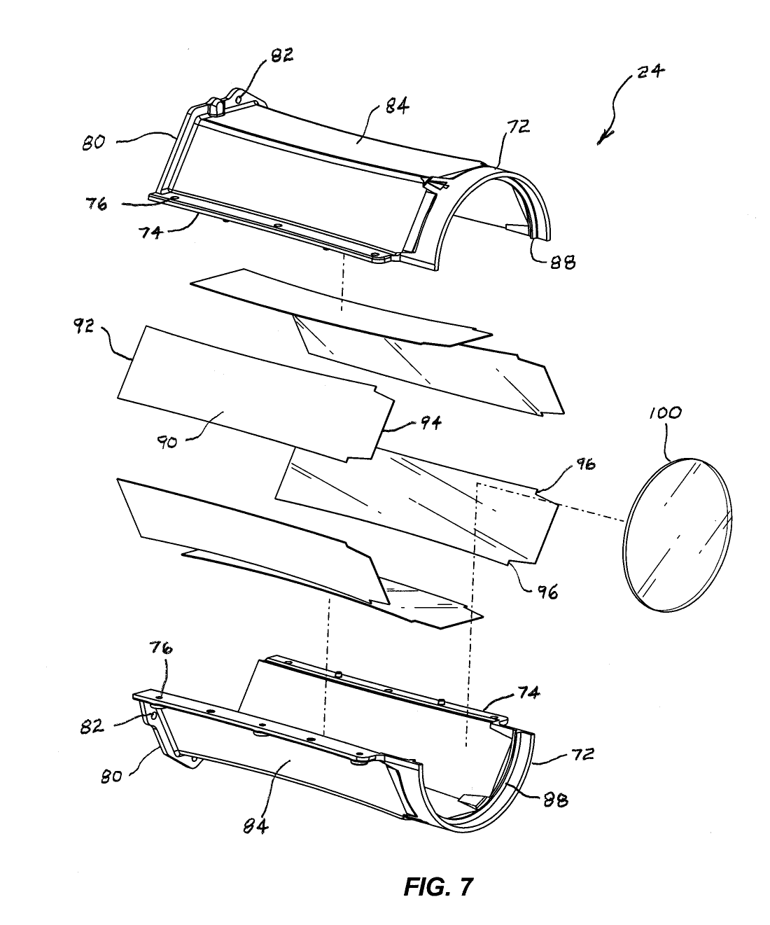

Referring to FIGS. 3 and 7, the illustrated mixing assembly 24 includes a reflective mixing tube 70 made from two substantially identical half housings 72. Each half housing 72 includes a pair of opposing side flanges 74 and corresponding flange holes 76 that are adapted to align and mate with the side flanges 74 and flange holes 76 of the other half housing 72. Fasteners (not shown) are then used to secure the half housings 72 together to form the mixing tube 70. The inlet end of the mixing tube 70 near the light source 22 includes an end flange 80 having four end holes 82 that are positioned to be aligned with the mounting holes 48 in the primary optic holder 40 and the mounting holes 32 in the printed circuit board 30. Fasteners (not shown) are positioned through the end holes 82 to secure the mixing tube 70 to the primary optic holder 40 and printed circuit board 30.

The mixing tube 70 has a substantially hexagonal cross-sectional shape made from six sidewalls 84. As best shown in FIGS. 3 and 7, each sidewall is curved such that an outer surface of each sidewall 84 is slightly concave, resulting in a mixing tube 70 that has an interior that defines a converging section 86 and a diverging section 87. In the illustrated embodiment, the interior surface of the mixing tube (as shown in FIG. 3) defines a substantially parabolic path, which improves light mixing by forcing more interaction of light rays with the tube in the first third of its length. An additional benefit of this design is that it produces a peaked, or cosine-type light profile that facilitates the blending of light from multiple fixtures. The outlet end of the mixing tube 70 near the gate assembly 26 includes an annular flange 88, the function of which is described below.

The illustrated mixing assembly 24 further includes six mirrors 90 positioned inside the mixing tube 70, with each mirror 90 having an inlet end 92 and an outlet end 94. Each mirror 90 is made from a flexible material that facilitates the mirror following the curved contour of a corresponding side wall 84 of the mixing tube 70. The inlet end 92 of each mirror 90 is held in place by the corresponding mirror tabs 50 on the primary optic holder 40. The mirrors 90 are adhesively bonded to the inner surface of the mixing tube 70 such that they follow the curved contour of the sidewalls 84 of the mixing tube 70.

In the illustrated embodiment, the reflective surface of the mirrors is specular aluminum, such as Alanod MIRO. Alternatively, the reflective surface could be a prismatic light guide (e.g., having a V-groove structure), such as 3M® Optical Lighting Film.

As noted above, the illustrated mirrors 90 create a reflective surface that is longitudinally curved (i.e., curved along a longitudinal path—moving from the inlet to the outlet). In one embodiment, the reflective surface follows a substantially parabolic path. However, other curved paths can also be used, such as an ellipse or other aspheric surface. By virtue of the curved sidewalls 84, the reflective surfaces of the mirrors 90 define a converging-diverging path with a narrowest portion that defines a waist 98 (see FIG. 3). In the illustrated embodiment, the waist 98 is closer to the inlet end 92 of the mirrors 90 than to the outlet end 94 of the mirrors 90.

In another embodiment, the curved path of the mirrored surface can be adjusted. For example, the mixing assembly can include adjusters in the form of set screws threaded through the sidewalls 84 of the mixing tube 70 and engaging each mirror 90 at or near the waist 98. By turning the set screws, the waist can be increased or decreased. In addition, multiple threaded openings can be provided along the length of the sidewalls 84 to facilitate positioning the adjusters at different locations along the length of the mixing tube 70, thereby adjusting the longitudinal position of the waist 98.

The mixing assembly 24 further includes a field lens 100 mounted in the mixing tube 70 near the outlet end 94 of the mirrors 90. The field lens 100 is designed to modify the output etendue of the mixing assembly 24 to better match the input etendue of the lens assembly 28. In the illustrated embodiment, the field lens 100 is sandwiched between the outlet end 94 of the mirrors 90 and the annular flange 88 in the mixing tube 70.

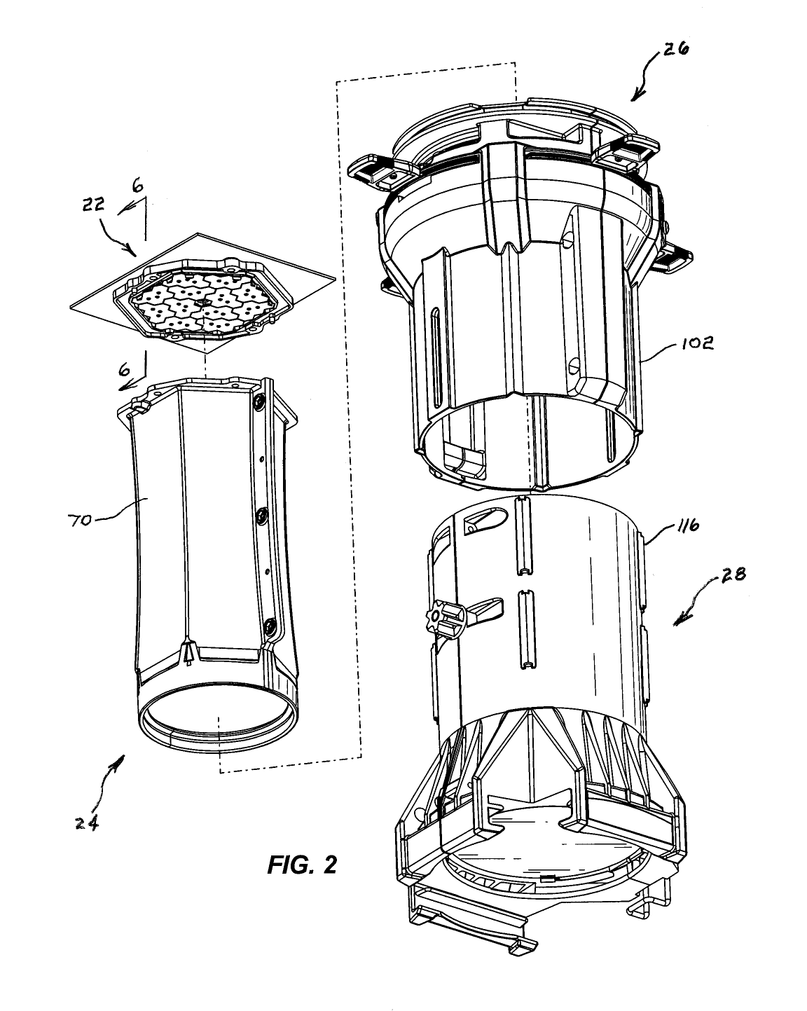

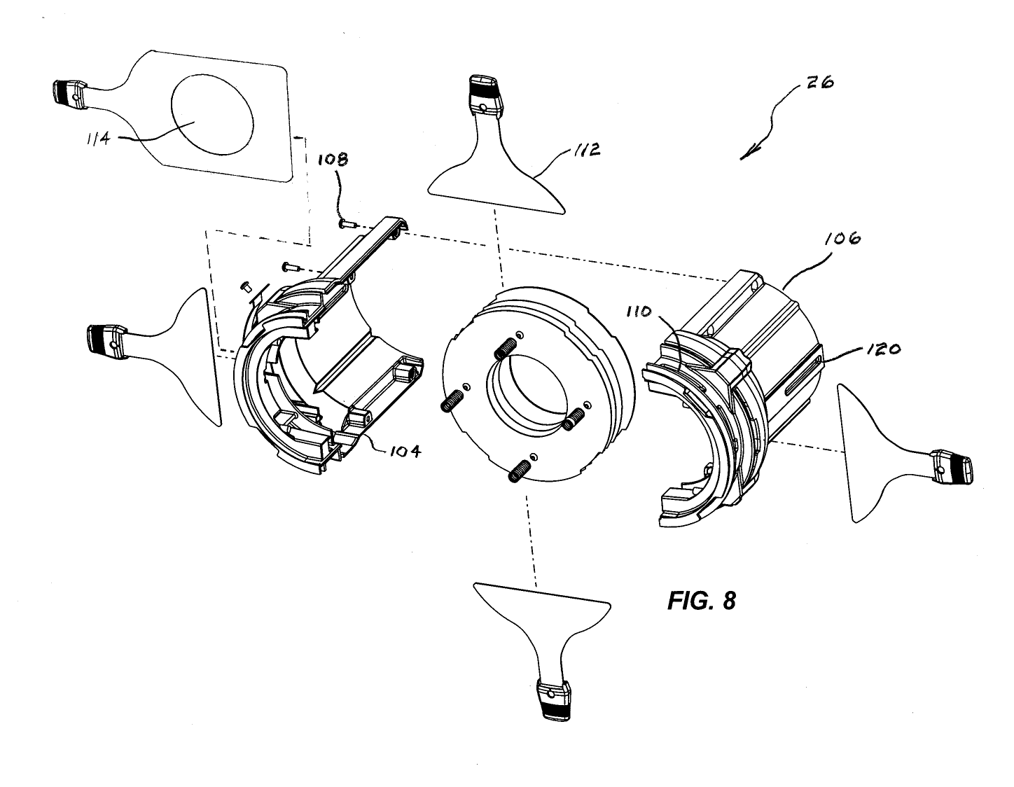

Referring to FIGS. 2, 3, and 8, the gate assembly 26 includes a gate housing 102 made in two halves (104,106) secured together with fasteners 108 similar to the mixing tube 70. The gate housing 102 is secured to the mixing tube 70 by an outer support housing (not shown). The illustrated gate housing 102 includes four annular slots 110 that provide radial access to the interior of the gate housing 102. A shutter 112 is positioned in each annular slot, as is generally known in the art to provide shuttering capability. Another annular slot 113 (FIG. 3) can also be used to introduce a diffuser 114 (FIG. 8) into the system. The diffuser can assist with reduction of multi-colored shadows that can occur with LED lighting systems.

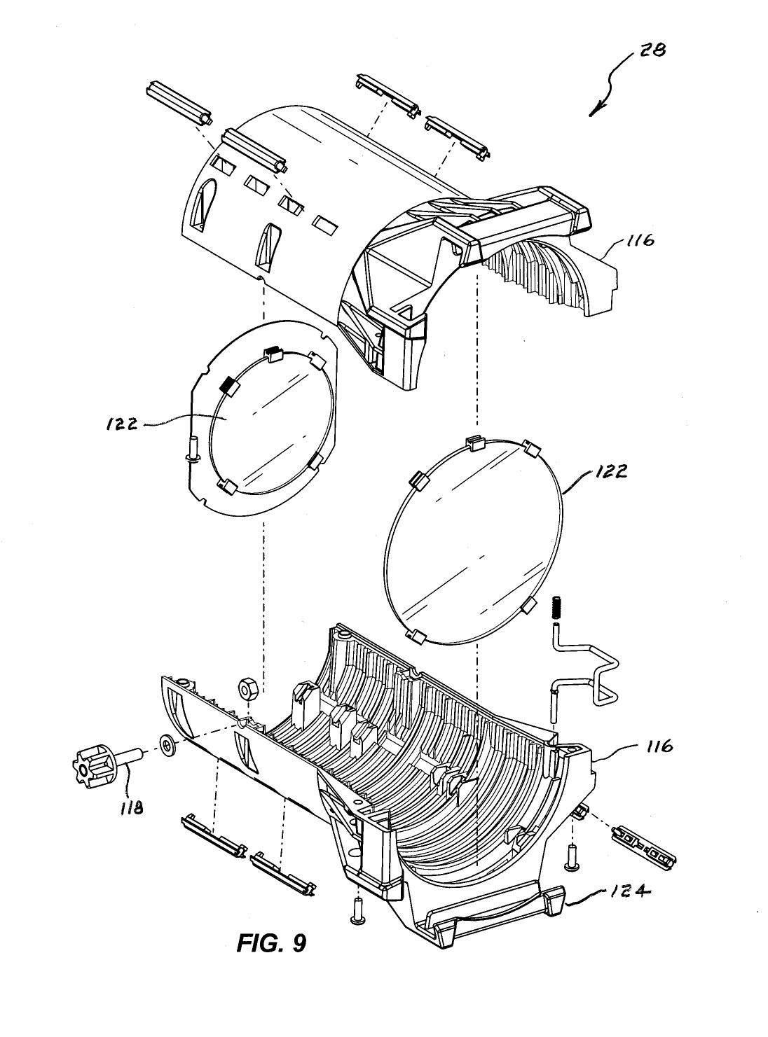

Referring to FIGS. 2, 3, and 9, the lens assembly 28 includes a two-piece projection lens housing 116 that is secured to the gate housing 102 by two opposing fasteners 118. The purpose of the projection lens is to image the gate and shutters on the wall, as is known in the art. Each fastener 118 is positioned through a slotted opening 120 in the gate housing to facilitate longitudinal adjustment of the lens assembly 28 relative to the gate assembly 26, as is known in the art. Lenses 122 are supported in the lens housing. The end of the lens assembly 28 can include a frame holder 124 that facilitates the use of various filters and the like.

Additional details regarding the gate assembly 26 and lens assembly 28 can be found in U.S. Pat. No. 5,345,371, which is hereby incorporated by reference in its entirety.

1. A lighting fixture comprising:
a light source including an array of LEDs;
a plurality of collimating optics, each positioned to collimate light from at least one of the LEDs; and
a light-mixing assembly positioned to receive light from the collimating optics, the light-mixing assembly comprising a reflective tube having a converging section and a diverging section.

2. A lighting fixture as claimed in claim 1, wherein the array comprises LEDs having a plurality of colors.

3. A lighting fixture as claimed in claim 2, wherein at least one of the LEDs comprises an amber LED and at least one of the LEDs comprises the a white LED, and wherein the amber LED and the white LED are positioned on a perimeter of the array.

4. A lighting fixture as claimed in claim 1, wherein the collimating optics are molded plastic optics that work via total internal reflection.

5. A lighting fixture as claimed in claim 1, wherein the collimating optics are a photonic lattice structure applied to the LEDs

6. A lighting fixture as claimed in claim 1, wherein the reflective tube comprises a polygonal cross section.

7. A lighting fixture as claimed in claim 1, wherein the reflective tube has a reflective surface including specular aluminum (such as Alanod MIRO).

8. A lighting fixture as claimed in claim 1, wherein the reflective tube has a reflective surface including a prismatic V-groove structure (such as 3M Optical Lighting Film).

9. A lighting fixture as claimed in claim 1, wherein the reflective tube includes a necked portion between the converging section and the diverging section.

10. A lighting fixture as claimed in claim 1, wherein a sidewall of the reflective tube is longitudinally curved.

11. A lighting fixture as claimed in claim 10, wherein a shape of the sidewall of the reflective tube comprises an asphere.

12. A lighting fixture as claimed in claim 10, wherein a shape of the sidewall of the reflective tube comprises a parabola.

13. A lighting fixture as claimed in claim 1, wherein a shape of a sidewall of the reflective tube is adjustable to modify the light wash exiting the light-mixing assembly.

14. A lighting fixture as claimed in claim 1, further comprising a gate assembly and a projection lens on an output side of the gate assembly.

15. A lighting fixture as claimed in claim 14, further comprising a field lens between the light-mixing assembly and the lens assembly, the field lens modifying an output etendue of the light-mixing assembly to better match an input entendue of the projection lens.
